(19) United States
(12) Patent Application Publication
(10) Pub. No.: US 2009/0181572 A1
(43) Pub. Date: Jul. 16, 2009

(54) Portable storage device

(76) Inventors: Mark S. Tracy, Tomball, TX (US); Paul J. Doczy, Cypress, TX (US); Earl W. Moore, Cypress, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/008,732

(22) Filed: Jan. 14, 2008

(51) Int. Cl. H01R 13/56; H01R 13/648; B32B 37/00

(52) U.S. Cl. 439/447; 156/242

(57) ABSTRACT

A portable storage device comprises a housing molded over a printed circuit board and a connector, the housing having a flexible portion and a rigid portion, the flexible portion disposed near the connector.

### BACKGROUND

When portable storage devices are connected to an electronic device, at least a portion of the portable storage device extends away from the electronic device. As a result, if an object or person forcefully comes into contact with the connected device, damage to the portable storage device and/or electronic device can result.

### BRIEF DESCRIPTION OF THE DRAWINGS

FIG. 1 illustrates an electronic device in which an embodiment of a portable storage device is employed to advantage;

FIGS. 2A, 2B and 2C illustrate a planar view of the portable storage device of FIG. 1 disposed in different flexed positions;

FIGS. 3A and 3B illustrate a cross-sectional view of the portable storage device of FIG. 2B taken along line 3-3 of FIG. 2B with the portable storage device disposed in different flexed positions; and

FIG. 4 is a flow chart illustrating an embodiment for a method of manufacturing a portable storage device.

### DETAILED DESCRIPTION OF THE DRAWINGS

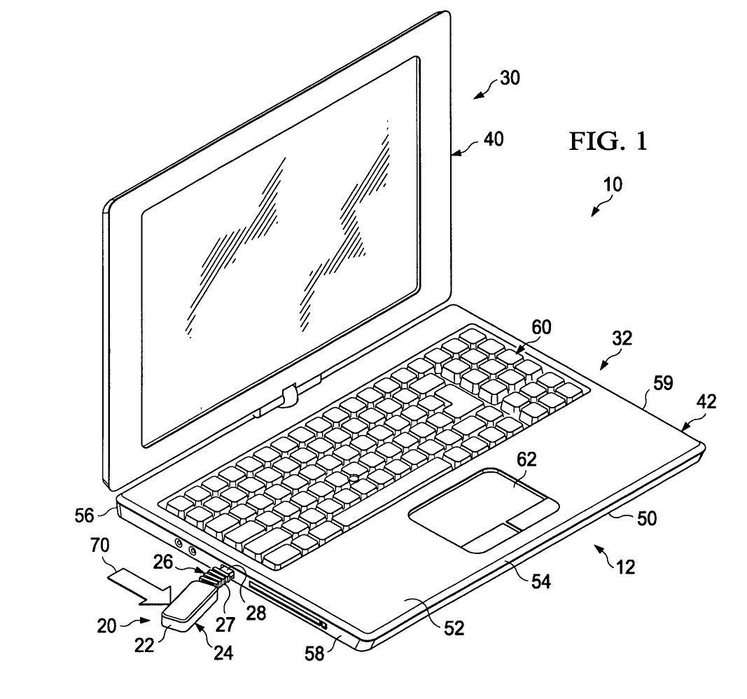

FIG. 1 illustrates an electronic device 10 in which an embodiment of a portable storage device 20 is employed to advantage. In the illustrated embodiment, electronic device 10 is a laptop or notebook computer 12. However, it should be noted that electronic device 10 can be any type of electronic device such as, but not limited to, a desktop computer, a tablet computer, a personal digital assistant (PDA), a cellular telephone or any other type of portable or non-portable electronic device.

In the illustrated embodiment, electronic device 10 comprises a display member 30 rotatably coupled to a base member 32. Display member 30 and base member 32 each comprise housings 40 and 42, respectively, for housing and/or supporting one or more components of electronic device 10. For example, in the illustrated embodiment, base member 32 comprises a bottom wall 50, a working surface 52, a front wall 54, a back wall 56, and side walls 58 and 59. In the embodiment illustrated in FIG. 1, working surface 52 comprises a keyboard 60 and a touchpad 62.

In FIG. 1, portable storage device 20 is coupled to electronic device 10 along side wall 58 of housing 42 of base member 32. However, it should be understood that portable storage device 20 may be coupled to electronic device 10 at other locations (e.g., walls, 54, 56, or 59 or in display member 30). Portable storage device 20 is configured to store data and/or information for use by electronic device 10. Portable storage device 20 comprises a housing 22 having a rigid portion 24 and a flexible portion 26. In some embodiments, housing 22 is made from a moldable material (e.g., thermoplastic elastomer, rubber, etc.). In some embodiments, rigid portion 24 and flexible portion 26 of housing 22 are over-molded together and/or form a unitary and/or essentially single unit. Rigid portion 24 is a substantially unbendable and/or inflexible segment of housing 22 and is configured to protect electronic components housed within rigid portion 24 of housing 22. Flexible portion 26 is configured to enable omnidirectional movement of at least a portion of portable storage device 20 relative to another portion of portable storage device 20. As used herein, “omnidirectional movement” may comprise a single degree of freedom or multiple degrees of freedom of movement (e.g., at least three degrees of freedom of movement (e.g., pitch, yaw and roll)). Therefore, in operation, flexible portion 26 is configured to enable at least a portion of portable storage device 20 to move and/or bend in response to an applied force (e.g., illustrated by arrow 70). In FIG. 1, flexible portion 26 comprises a compressible ribbed portion 27. However, it should be understood that flexible portion 26 may comprise one or more pattern types and/or construction configured to enable omnidirectional movement of at least a portion of portable storage device 20 (e.g., an accordion-like pattern, a bunched pattern, a flexible corrugated construction, a flexible grooved construction, a planar construction, etc.). It should be further understood that compressible ribbed portion 27 may comprise a portion or all of flexible portion 26.

In FIG. 1, portable storage device 20 comprises a connector 28. Connector 28 can be any type of interface which is engageable and/or connectable with a mating interface disposed along any of walls 54, 56, 58, and 59 of base member 32 or of display member 30 of electronic device 10. In some embodiments, flexible portion 26 is disposed between connector 28 and rigid portion 24. In the illustrated embodiment of FIG. 1, portable storage device 20 is disposed along side wall 58 of electronic device 10, and connector 28 is a Universal Serial Bus (USB) connector. However, it should be understood that portable storage device 20 may be coupled to electronic device 10 using any other type of connector (e.g., modular connector, fiber connector, etc.). Furthermore, it should be understood that housing 22 may be used and/or applied to other types of devices other than a storage device that may be connected to and/or otherwise extend from an electronic device (e.g., electronic device 10) and/or be susceptible to breaking and/or being otherwise damaged (e.g., cables having a DB connector or a DIN connector, adapters, etc.).

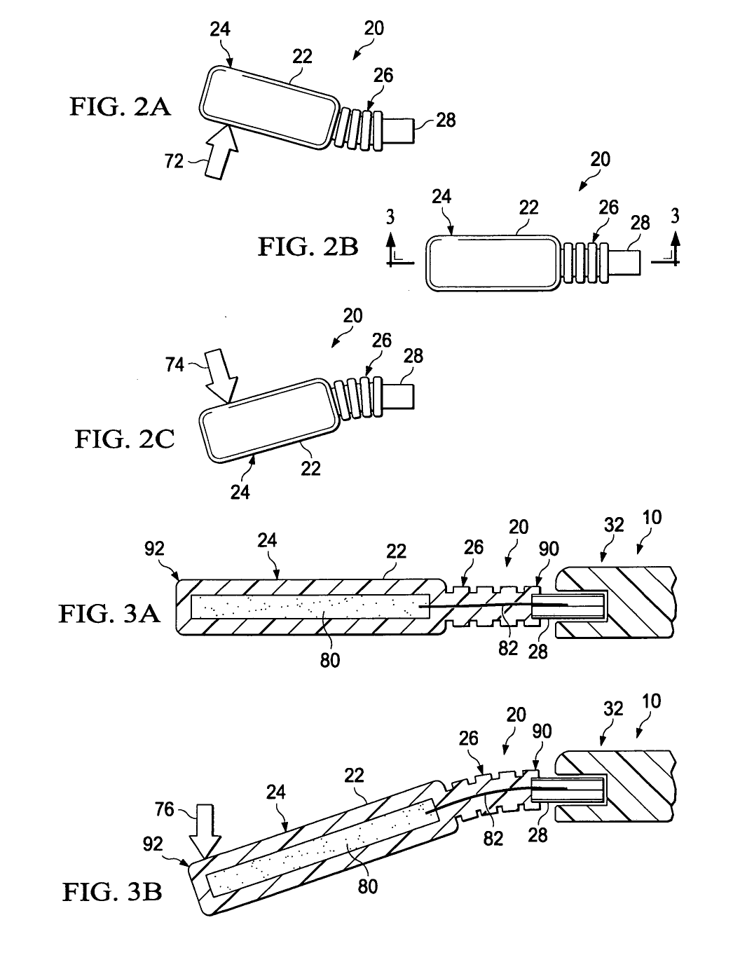

FIGS. 2A, 2B and 2C illustrate a planar view and/or top-down view of portable storage device 20 disposed in different flexed positions. FIG. 2A illustrates flexible portion 26 bending in a direction corresponding to the direction indicated by arrow 72. In FIGS. 2A and 2C, it should be understood that connector 28 is located in a fixed position (e.g., installed into a connector port of electronic device 10) and receives a force in the direction indicated by arrows 72 and 74, respectively, at or near an opposite end of portable storage device 20. Referring to FIG. 2A, in response to a force is applied to housing 22 at or near rigid portion 24 in a direction corresponding to the direction indicated by arrow 72, rigid portion 24 also correspondingly moves in the same direction indicated by arrow 72 relative to connector 28 via flexible portion 26. Referring to FIG. 2B, portable storage device 20 is disposed in a neutral position or in a position when no force is applied to portable storage device 20. In FIG. 2C, portable storage device 20 is disposed in a position similar to the position of portable storage device 20 as illustrated in FIG. 1. In FIG. 2C, in response to a force is applied to housing 22 at or near rigid portion 24 in a direction corresponding to the direction indicated by arrow 74, rigid portion 24 also correspondingly moves in the same direction indicated by arrow 74 relative to connector 28 via flexible portion 26. Therefore, portable storage device 20, as illustrated in FIGS. 2A, 2B, and 2C, is configured to enable omnidirectional movement of at least a portion of housing 22 relative to connector 28 of portable storage device 20. As a result, portable storage device 20 is configured to flex and/or move in a direction corresponding to the direction of the applied force, thereby averting damage that may otherwise result from the force applied to portable storage device 20.

FIGS. 3A and 3B illustrate embodiments of a cross-sectional view of portable storage device 20 taken along line 3-3 of FIG. 2B. In FIGS. 3A and 3B, housing 22 illustrates rigid portion 24 and flexible portion 26 being a unitary and/or single unit. Rigid portion 24 houses a printed circuit board (PCB) 80 operatively connected to connector 28 via flexible connector 82. PCB 80 is configured to store data and/or information for portable storage device 20. Flexible connector 82 comprises a set of one or more cables configured to transmit data between PCB 80 and the electronic device (e.g., electronic device 10) to which connector 28 is coupled. Flexible connector 82 may comprise a flexible ribbon cable configured to be flexible and/or bendable so that at least a portion of flexible connector 82 can move in a corresponding direction with rigid portion 24 and/or flexible portion 26 of housing 22. It should be understood, however, that flexible connector 82 may also comprise other types of flexible cable.

FIGS. 3A and 3B illustrate housing 22 having an open end 90 and a closed end 92. Rigid portion 24 comprises closed end 92 and flexible portion 26 comprises open end 90. In the illustrated embodiments, open end 90 surrounds at least a portion of connector 28 to couple housing 22 to connector 28. It should be understood that housing 22 may be coupled to at least a portion of connector 28 using any type of method such as, but not limited to, bonding and/or pressure based process (e.g., using an adhesive, fused, vulcanized, etc.).

In FIG. 3A, portable storage device 20 is in a neutral position. FIG. 3B illustrates rigid portion 24 of housing 22 bending in a direction corresponding to the direction illustrated by arrow 70 relative to connector 28 via flexible portion 26. As shown in FIG. 3B, when engaged with and/or coupled to electronic device 10, flexible portion 26 enables rigid portion 24 to bend in the direction corresponding to the direction illustrated by a force applied against rigid portion 24 (e.g., the direction illustrated by arrow 76). As flexible portion 26 bends and/or flexes relative to connector 28, flexible connector 82 correspondingly flexes with flexible portion 26 of housing 22. Rigid portion 24 and PCB 80, housed within rigid portion 24, remains substantially planar and/or flat relative to flexible portion 26 as rigid portion 24 and PCB 80 correspondingly move in the direction that flexible portion 26 bends. By remaining substantially planar, rigid portion 24 protects PCB 80 from potentially damaging bending and/or twisting when a force is applied to rigid portion 24.

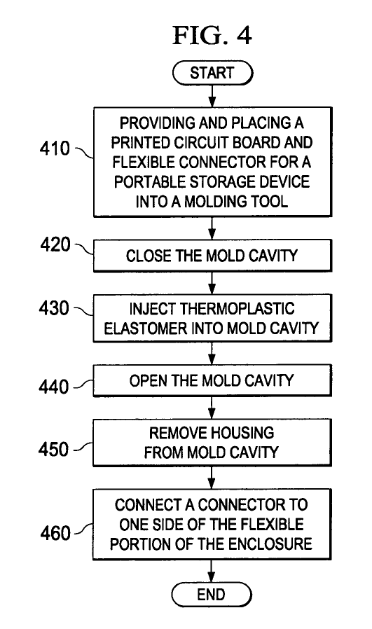

FIG. 4 is a flow chart illustrating an embodiment for a method of manufacturing portable storage device 20. The method begins with block 410 where PCB 80 and flexible connector 82 are provided and placed into the mold cavity of a molding tool. The mold cavity is then closed (block 420) and a thermoplastic elastomer or other type of elastomeric compound is injected into the mold cavity such that housing 22 is formed having rigid portion 24 and flexible portion 26 molded over PCB 80 and flexible connector 82 (block 430). The mold cavity is then opened (block 440) and PCB 80 and flexible connector 82 overmolded by housing 22 are removed from the mold cavity (block 450). Connector 28 is then coupled to one side of flexible portion 26 of housing 22 using any type of bonding and/or pressure based process (block 460), with the process terminating thereafter. However, in some embodiments, connector 28 is also provided at block 410 (included in the mold cavity when the elastomer compound is injected thereto) and subsequently follows the process to block 450, with the process terminating thereafter.

Therefore, embodiments of portable storage device 20 are configured with a rigid portion 24 and a flexible portion 26. Flexible portion 26 is configured to deflect and/or move in response to a force applied to any portion of portable storage device 20. The ability of flexible portion 26 to move prevents rigid portion 25 from internal bending and/or moving, thereby preventing internal components (e.g., PCB 80) to potentially become damaged and/or inoperative. Furthermore, the ability of flexible portion 26 and flexible connector 82 to correspondingly move with flexible portion 26 prevents portable storage device 20 from breaking and/or losing connection with an electronic device (e.g., electronic device 10) to which portable storage device 20 is connected.

1. A portable storage device, comprising:
a housing molded over a printed circuit board and a connector, the housing having a flexible portion that includes flexible ribs and a rigid portion housing the printed circuit board, the flexible portion disposed between the rigid portion and the connector enabling the rigid portion to move in three different degrees of freedom with respect to the connector when the connector is connected to a computer.

2. The device of claim 1, wherein the flexible portion houses wiring coupling the printed circuit board to the connector.

3. The device claim 1, wherein the rigid portion houses the printed circuit board.

4. The device of claim 1, wherein the three different degrees of freedom include pitch, yaw, and roll.

5. The device of claim 1, wherein the housing is formed of a thermoplastic elastomer.

6. The device of claim 1, wherein the flexible ribs are compressable.

7. A method of manufacturing a portable storage device, comprising:
molding a housing for the portable storage device over a printed circuit board and a connector, the housing having a flexible portion that includes flexible ribs and a rigid portion including the printed circuit board, the flexible portion disposed between the rigid portion and the connector enabling the housing to move in three different degrees of freedom with respect to the connector when the portable storage device is connected to a computer.

8. The method of claim 7, further comprising molding the flexible portion over wiring configured to couple the printed circuit board to the connector.

9. The method of claim 7, further comprising molding the rigid portion of the housing over the printed circuit board.

10. The method claim 7, wherein the three different degrees of freedom include pitch, yaw, and roll.

11. The method of claim 7, wherein the ribs compress.

12. The method of claim 7, further comprising forming the housing from a thermoplastic elastomer.

13. A portable storage device, comprising:
a rigid housing including a printed circuit board located in the rigid housing;
a connector that connects to a computer; and
a flexible portion disposed between the rigid housing and the connector, wherein the flexible portion flexes so the rigid housing is movable in three different degrees of freedom when the connector is connected to the computer.

14. The device of claim 13, wherein the flexible portion comprises an open end coupled to a portion of the connector.

15. The device of claim 13, wherein the rigid portion comprises a closed end.

16. The device of claim 13, wherein the three different degrees of freedom include pitch, yaw, and roll.

17. The device of claim 13, wherein the flexible portion includes ribs that compress.

18. The device of claim 13, wherein the flexible portion comprises wiring coupling the connector to a printed circuit board.

19. The device of claim 13, wherein the housing is overmolded onto the connector.

20. The device of claim 13, wherein the connector comprises a Universal Serial Bus (USB) connector.
